(19) United States
(12) Patent Application Publication
(10) Pub. No.: US 2003/0230725 A1
(43) Pub. Date: Dec. 18, 2003

(54) Sensor arrangement having a capacitive light sensing circuit

(76) Inventor: Bravo Wong, Hong Kong (CN)

Correspondence Address: BROOKS KUSHMAN P.C., 1000 TOWN CENTER, TWENTY-SECOND FLOOR, SOUTHFIELD, MI, 48075, US

(21) Appl. No.: 10/407,562

(22) Filed: Apr. 4, 2003

(30) Foreign Application Priority Data
Apr. 4, 2002 (CN) 2002-102926

(51) Int. Cl. G01J 5/00

(52) U.S. Cl. 250/372

(57) ABSTRACT

A system for detecting light intensity including a light sensor for sensing light intensity having a capacitance which varies based on light intensity. The light sensor includes first and second layers forming first and second electrodes and a photosensitive dielectric layer disposed between the first and second electrodes. The photosensitive dielectric layer has a dielectric constant that varies with light intensity such that the sensor has a capacitance representative of light intensity. A controller in communication with the sensor measures the capacitance of the sensor, compares the measured capacitance values to stored capacitance values and generates an output signal based on the comparison. The output signal is configured for use in providing an indication of light intensity.

### BACKGROUND OF THE INVENTION

1. Field of the Invention

This invention relates to a system having a light sensing circuit and more particularly to a light intensity sensor having a light sensitive film for detecting and measuring the intensity of ultraviolet radiation.

2. Background Art

The hazards of ultraviolet (UV) radiation are well known. One of the most common sources of ultraviolet radiation is UV rays generated by sun light or artificial light sources such as lights in a tanning salon bed. Ultraviolet rays are generally classified as either ultraviolet A (UVA) or ultraviolet B (UVB) rays. Excessive exposure to these ultraviolet lights, especially UVB rays, can lead to skin tissue damage. In recent years, scientists have also recognized the harmful effects of UVA rays on skin tissue.

Although ultraviolet radiation plays a vital role in the human body's ability to produce vitamin D, overexposure to such rays commonly results in a sunburn condition. Sunburn not only causes a great deal of immediate discomfort, it can lead to other skin problems, such as skin cancer or photo-aging. Skin cancer and photo-aging are not mutually exclusive. Rather, the conditions often coincide and coexist as a result of years of excessive sun exposure. Generally, those having severe sunburns or numerous sunburns are subject to a high risk of skin cancer.

Photo-aging, on the other hand, is a process of skin changes resulting from overexposure to sun over a number of years. These skin changes include color, wrinkles, freckles, dryness, skin growths, easy bruising, and liver spots. As with skin cancer, photo-aging is more prevalent in humans who are susceptible to sunburn, especially those with fair skin.

Human susceptibility to ultraviolet radiation is dependent upon many factors, including time of day, weather, altitude, and proximity to reflective surfaces. Humans are unable to detect the amount of ultraviolet radiation they are exposed to until the radiation's effects show up in the form of a sunburn. Recently, several health equipment systems have appeared on the market to measure the intensity of ultraviolet light. These sunburn alarms provide information to prevent sunburn, or additional sun related skin disorders. For example, ultraviolet light intensity information can be used to select the appropriate type of sun screen protection, or to determine how long to remain outdoors on days with extremely strong ultraviolet light.

The light sensors of existing sunburn alarm systems typically utilize solar powered batteries and photo diodes to detect ultraviolet radiation conditions. The photo diodes typically include a thin semiconductor wafer formed of silicon, germanium or gallium that converts incident light photos into electron-hole pairs. The semiconductive materials form a thin disk crystalline lattice structure of about 20-30 cm in diameter having about 15,700 individual sensors fabricated on a single 20 cm disk.

A typical fabrication plant considers 25 disks as a single production unit forming 392,500 photo diode sensors. Therefore, the production of only a few thousand photo diodes is difficult and expensive. Further, both silicon, germanium in crystal form are essentially insulators and conduct little electricity because they exhibit a high degree of chemical purity and do not provide a photo-electronic response. For these elements to provide a photo-electronic response, a process known as doping must be used to create a lattice defect, or an electron hole in the crystallized matter. Accordingly, trace amounts of impurities need to be added to the crystalized matter creating the lattice defect to produce much greater conductivity. Especially with crystal-based light sensors, materials added to the crystallization such as arsenic or potassium are generally hazardous to humans.

In photo sensors using semi-conductor crystallization technology, the atoms that constitute the crystal and its alignment are already predetermined. Therefore, with the crystallization structure included, the light wavelength and sensitivity characteristics are established. There are no other choices for wavelength selection.

In lower priced light sensors, cadmium sulfide is often used as the resistive element. However, cadmium sulfide is poisonous, and therefore, not desirable for assembly or use. In addition, cadmium sulfide is only sensitive to specific light wavelengths associated with visible light, thus limiting its usefulness in detecting harmful ultraviolet radiation or rays.

Crystal based light sensors suffer additional limitations which reduce the effectiveness of sensors. The photo electronic effect of crystal-based light sensors converts the incoming light into electrical current. However, analog electronic circuits are required to amplify these minute electrical currents, raising them to levels where other circuits can process them. Thus, electrical consumption becomes problematic and consistent operation becomes difficult in battery driven instruments.

It would be advantageous to provide a system having a light sensing circuit using a capacitive light sensing film for detecting and measuring the intensity of ultraviolet rays which solves the problems referenced above. Further, it would be advantageous to provide an inexpensive and safe way of producing a light sensing film for measuring the intensity of ultraviolet radiation. It would also be advantageous to provide a system for detecting and measuring light intensity which allows for greater freedom in selecting the particular light wave lengths to be sensed and which uses low-power electronic circuitry to generate the light intensity signal.

### SUMMARY OF THE INVENTION

Accordingly, a system having a sensor detecting light intensity using a light sensing film is disclosed. The system includes a light sensor for sensing light intensity having a capacitance which varies based on light intensity. The light sensor includes first and second layers forming first and second electrodes and a photosensitive dielectric layer disposed between the first and second electrodes.

The photosensitive dielectric layer has a dielectric constant that varies with light intensity such that the sensor has a capacitance representative of light intensity. A controller in communication with the sensor measures the capacitance of the sensor, compares the measured capacitance values to stored capacitance values and generates an output signal based on the comparison. The output signal is configured for use in providing an indication of light intensity.

The above aspects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a top plan view of a timepiece having a system for detecting light intensity in accordance with the present invention;

FIG. 2 is a cross-sectional view of the timepiece along line 2-2 of FIG. 1 illustrating the light intensity sensor of the present invention;

FIG. 3 is a cross-sectional view of the timepiece along line 3-3 of FIG. 1 illustrating the sensor housing of the present invention;

FIG. 4 is a plan view of the timepiece display panel of the present invention;

FIG. 5 is a cross-sectional view of the light sensing film of the system of the present invention;

FIG. 6 is a cross-sectional view of the photosensitive material of the light sensing film of the present invention;

FIG. 7 is a cross-sectional view illustrating an alternative aspect of the light sensing film of the present invention; and

FIG. 8 is a schematic view illustrating an example of the system of the present invention.

### DETAILED DESCRIPTION OF THE PREFERRED EMBODIMENTS

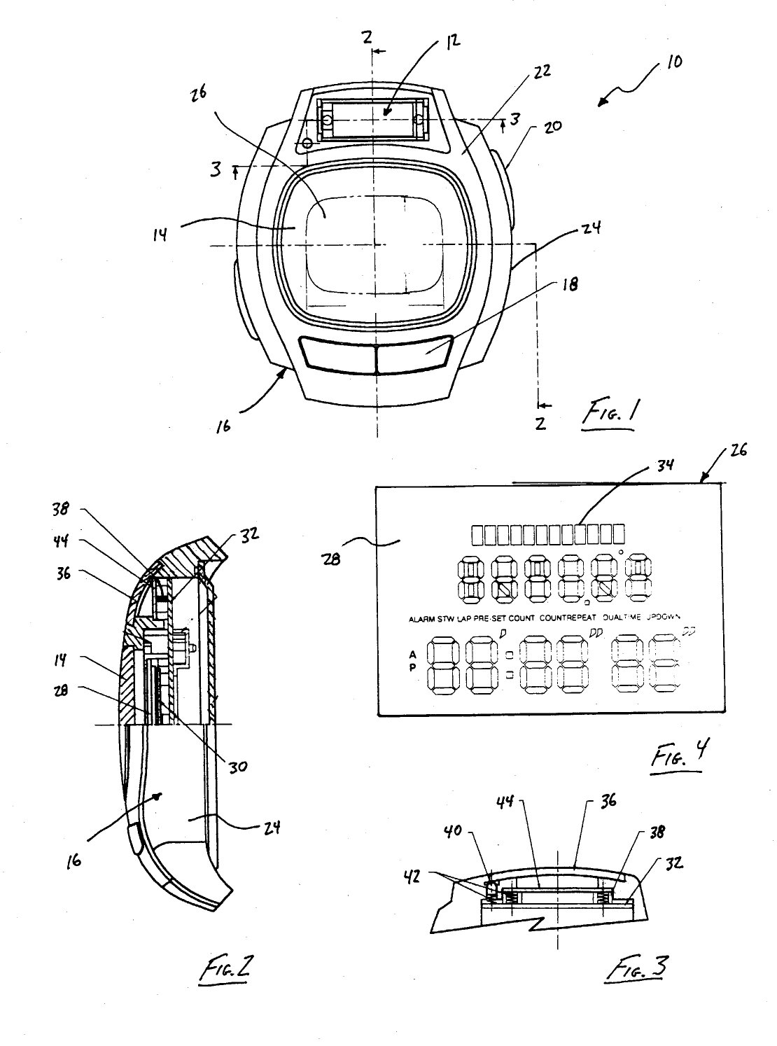

Referring now to the Figures, a system having a sensor for detecting light intensity is disclosed. FIG. 1 illustrates a preferred aspect of the invention. A timepiece or watch 10 including an optical sensor 12 having a light sensing film is provided proximate a face portion 14 of the watch housing 16. Face portion 14 is generally formed of a transparent polymeric or glass material disposed above a display 26 of watch 10. Watch housing 16 includes a plurality of buttons 18, 20 provided on exterior surfaces of the housing 16 to allow an operator to control a variety of functions of the watch 10.

For example, buttons 18 are provided on a front surface 22 of housing 16 to control a stop watch or timer function incorporated in watch 10. Buttons 20 provided on side surfaces 24 of watch housing 16 may control watch functions such as activating a backlighting panel or light emitting diode (LED) which illuminates the display 26 of the disposed below the face 14 of watch housing 16. It is understood that ultraviolet sensor 12 can be incorporated with a variety of watch styles, including a digital timepiece, analog timepiece, or a combination of both.

Display 26 includes a liquid crystal display (LCD) panel 28 provided within watch housing 16 below protective lens or face 14. LCD panel 28 is operably connected to a control circuit 30 on printed circuit board 32 to provide a graphic display of relevant information to the user. For example, as illustrated in FIG. 4, the watch may display the current time in hours, minutes and seconds as well as date information. Alternatively, the display panel 28 may illustrate countdown timer, stopwatch and alarm functions activated when the user controls these functions using buttons 18, 20. LCD display panel 28 further includes a bar line display 34 which illustrates an indication of ultraviolet light intensity based on an output signal. A further description of the method of detecting ultraviolet light intensity will be discussed in great detail below.

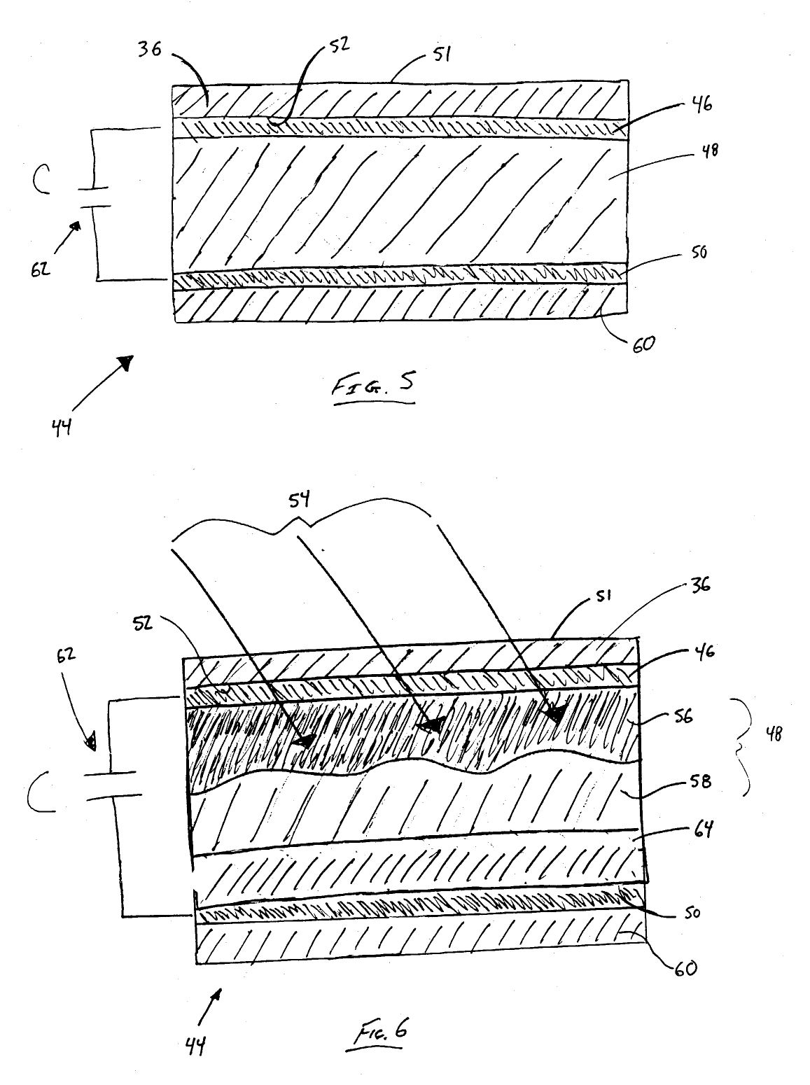

Referring now to FIGS. 2 or 3, sensor 12 is disposed proximate the front surface 22 of the watch housing 16 above the face portion 14 of LCD panel 28 to detect ultraviolet light intensity. A protective layer or cover 36 extends above ultraviolet sensor 12 to protect the sensor 12 from physical damage. Cover 36 generally comprises a transparent polymeric or glass material and may include a filter to assist sensor 12 in the detection of ultraviolet rays. Ultraviolet sensor 12 is operably connected to printed circuit board 32 via a sensor spring 38. Temperature sensor 40 provided adjacent ultraviolet sensor 12 below cover 36 is connected to printed circuit board 32 by sensor spring 42 to detect the ambient temperature adjacent cover 36.

Referring now to FIGS. 5-8, a description of the system of the present invention is described in greater detail. Sensor 12 includes a light sensing film 44 for sensing light intensity. Light sensing film 44 includes a first layer having a first electrode 46, a second layer including a second electrode 50 and a photosensitive dielectric layer 48 disposed therebetween. In one aspect of the invention, film 44 is disposed proximate protective layer 36. In an alternative aspect of the invention, protective layer 36 comprises a transparent plastic layer integrated into the light sensing film 44.

In one aspect of the invention illustrated in FIG. 5, protective layer or cover 36 comprises a transparent plastic layer which forms a physical protection barrier for light sensing film 44 which allows light to pass therethrough. Cover 36 includes a top surface 51 and a lower surface 52 disposed proximate the first electrode 46. In a preferred aspect of the invention, protective layer 36 is printed or evaporation coated as the backing material for the first electrode 46.

First electrode 46 is formed of a transparent conductive material which allows light to pass through to the photosensitive dielectric layer 48. First electrode 46 is preferably formed as an indium tin oxide (ITO) film comprising indium oxide (In₂O₃) doped with tin oxide (SnO₂). It is understood that ITO coatings provide outstanding electronic conductors while having optically transparent characteristics. In one aspect of the present invention, the ITO film of the first electrode 46 is vacuum deposited in a thin film on the bottom surface 52 of transparent protective layer or cover 36 using a process known as magnetron sputtering to create a high molecular compound film.

Photosensitive dielectric layer 48 is disposed between the first electrode 46 and the second electrode 50. Photosensitive dielectric layer 48 includes a photosensitive dielectric material, such as common flourescent material, cadmium sulfide (CdS), or zinc sulfide (ZnS) for detecting the wavelength of light 54 passing through layer 36 and first electrode 46. Photosensitive dielectric layer 48 is preferably screen printed to transparent first electrode 46. However, it is fully contemplated that photosensitive dielectric layer 48 may be formed proximate the first layer by other means to a variety of thicknesses. The electron orbit of the particles of the photosensitive dielectric material 48 will change according to light wavelengths and strengths. The change in the electron orbit will appear as a change in the dielectric constant of the photosensitive material.

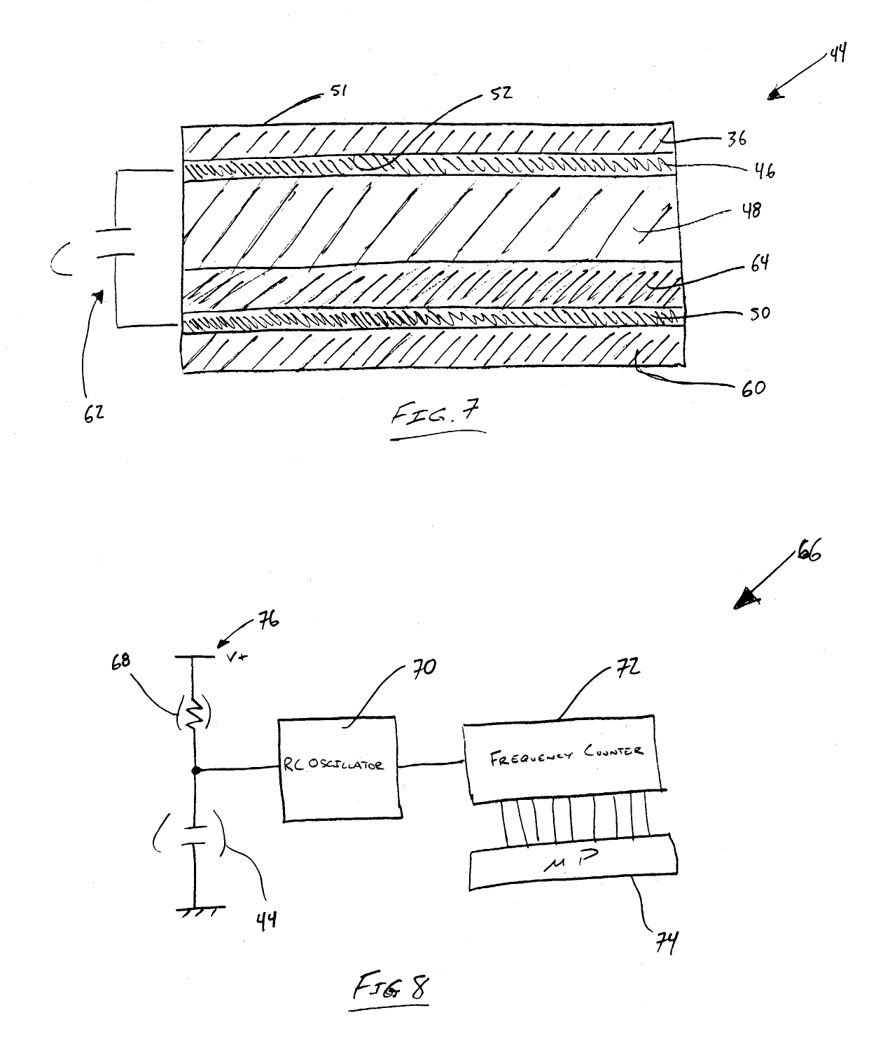

Referring additionally now to FIG. 6, photosensitive dielectric layer 48 is illustrated with an excited portion 56 and an unexcited portion 58. Excited portion 56 of dielectric layer 48 is activated and excited by light 54 passing through cover 36 and first electrode 46, while unexcited portion 58 of dielectric layer 48 remains inert. The dielectric layer 48 is sensitive to inherent light wavelengths and is excited by a reaction to specific wavelengths of light. Changes in light intensity alters the dielectric layer's 48 ability to support an electric field between the first electrode 46 and second electrode 50, thereby varying the capacitance of light sensing film 44.

In one aspect of the present invention, photosensitive dielectric layer 48 is formed of zinc sulfide which may display a light sensitivity down to 350 angstroms (or 35 nm), in accordance with the absorption wavelength of zinc sulfide. Further, in using zinc sulfide, there is minimal sensitivity to visible light, having wavelengths beginning near 400 nm. Ultraviolet radiation lies between wavelengths of about 100 nm on the x-ray side of the electromagnetic spectrum and about 400 nm on the side of visible light. In this manner, dielectric layer 48 of capacitive light sensing film 44 is suitable for sensing ultraviolet radiation in light 54.

Alternatively, selection of various photosensitive dielectric materials makes selection of various light wavelengths for sensing possible, thus measuring a wide spectrum of light wavelengths can be freely established. The photosensitive dielectric material 48 will display sensitivity to each inherent light wavelength. For example, if red flourescent material is used as the photosensitive dielectric layer, capacitive light sensing film 44 is more sensitive to red wavelengths. On the other hand, if white flourescent material (a mix of a variety of wavelengths) is used as photosensitive dielectric layer 48, capacitive light sensing film 44 is more sensitive to general visible light. In another aspect of the invention, a printable powder may be used as the photosensitive dielectric layer 48. By altering the photosensitive material of photosensitive dielectric layer 48, a particular light wavelength can be selected for measurement, thereby providing a degree of freedom in selecting wavelengths to monitor with watch 10. Additionally, the sensitivity and maximum intensity value of the light can be regulated by adjusting the thickness of photosensitive dielectric layer 48.

A lower protective material 60 is disposed proximate second electrode 50. Lower protective material 60 is preferably formed as a coating or plate for protecting the second electrode 50 and second dielectric layer 64. Although lower protective material 60 is included in a preferred embodiment of the present invention, it is fully contemplated that lower protective material 60 is not always necessary in this or alternative embodiments. Preferably, lower protective material 60 can be screen printed to a bottom surface of the second electrode 50. It is also understood that lower protective material 60 may be formed by other means, such as bonding or the like.

Transparent first electrode 46, second electrode 50 and dielectric layers 48 and 64 combine to form capacitor arrangement 62 of sensor 12. Capacitor 62 is a parallel plate capacitor having capacitance, C, approximated by:

$$C = \frac{{ϵ}_{o} {ϵ}_{r} A}{d} \qquad ( Eq . 1 )$$

where:

εₒ=permittivity of free space;

εᵣ=dielectric constant;

A=surface area of each electrode plate; and

d=distance between electrode plates.

In a preferred aspect of the invention, light 54 enters light sensing film 44 through the transparent protective layer 36 through the transparent first electrode 46, into the photosensitive dielectric layer 48. When the light 54 reaches the dielectric layer 48, the dielectric layer 48 senses and reacts to certain wavelengths or energy levels in light 54, increasing the dielectric constant, εᵣ. The stronger the light intensity, the farther the light 54 will penetrate into photosensitive dielectric layer 48, and subsequently, the higher the dielectric constant, εᵣ will rise. As a result, stronger light increases the capacitance, C, of capacitor 62.

In another aspect of the invention illustrated in FIGS. 6-7, lower dielectric layer 64 is disposed between photosensitive dielectric layer 48 and the second electrode 50. Lower dielectric layer 64 is provided to adjust the base capacitance, C, of capacitor 62. Referring to equation 1 above, capacitance, C, is generally proportional to the areas of the upper and second electrodes 46 and 50, as well as the dielectric constant of photosensitive dielectric layer 48. In this embodiment, the dielectric constant is determined by the combination of photosensitive dielectric layer 48 and lower dielectric layer 64.

Preferably, lower dielectric layer 64 is formed from a material such as barium titanate or the like. It is also understood that lower dielectric layer 64 may be omitted to adjust the capacitance, C, according to the required capacitance of capacitor 62 or to make the entire capacitive light sensing film 44 transparent relying only on photosensitive dielectric layer 48. If crystallizing compounds, such as zinc sulfide, are used to form the photosensitive dielectric layer 48, formation by evaporation is possible. In this event, by omitting lower dielectric layer 64 and by forming the second electrode 50 from ITO, capacitive light sensing film 44 becomes entirely transparent.

Referring now to FIG. 8, the system having a capacitive light sensing circuit 66 incorporating light sensing film 44 is described and shown. It is difficult to directly read the capacitance, C, of light sensing film 44. By integrating light sensing film 44 into light sensing circuit 66, an appropriate signal for measuring light intensity and ultraviolet radiation can be generated. In this embodiment, capacitive light sensing circuit 66 comprises a resistor 68, oscillator 70, frequency counter 72, controller 74 and power source 76 in communication with light sensing film 44. The oscillating frequency of oscillator 70 is determined by the series combination of the resistor 68 and light sensing film 44. Accordingly, changes in the capacitance, C, of light sensing film 44 result in changes in the oscillating frequency of oscillator 70. The following equation generally describes this relationship.

$$f = k \cdot \frac{1}{2 π RC} \qquad ( Eq . 2 )$$

In other words, the oscillating frequency, f, is proportional to the inverse value of capacitance, C, of light sensing film 44. According to normal conditions of light 54 entering the ultraviolet sensor 12, capacitance, C, will generally increase and the peripheral frequency, f, will generally decrease. Therefore, the strength of the light is distinguished by the degree of decrease of frequency, f. The oscillating frequency, f, of oscillator 70 is counted by frequency counter 72 and calculated by controller 74. Controller 74 indirectly detects the capacitance, C, of light sensing film 44, thereby detecting the intensity of light 54 detected by sensor 12.

Controller 74 can be programmed to send the various measured values of frequency counter 72 to external equipment. In a preferred aspect of the invention, the light intensity signal calculated by controller 74 can be utilized to generate a visual and/or audible sunburn alarm. In this embodiment, capacitive light sensing circuit 66 quantifies the amount of ultraviolet radiation present, compares the detected values against stored values and produces a desired preventive alarm if optimal ranges are exceeded.

In an alternative aspect of the invention, capacitive light sensing circuit 66 may be used in actinometers embedded in cameras for measuring visible light intensity in order to adjust aperture diaphragms. Actinometers typically use cadmium sulfide in their light sensors. A light sensing film 44 containing zinc sulfide may be substituted to perform the same functions with better results. If light sensing film 44 is configured as shown in FIG. 8, the actinometer will measure and display the intensity of light. However, in the case of ordinary silver film or digital camera, the wavelength sensitivity of the photosensitive dielectric material must match CCD over CMOS sensors. Ordinarily, flourescent materials can be used for this process.

In another alternative aspect of the invention, capacitive light sensing circuit 66 is utilized to detect visible sunlight for integration with an automatic street light switching device. Capacitive light sensing circuit 66 may be configured for sunlight quantity detection. As such, with a decrease in the amount of visible light, the capacitive light sensing circuit 66 determines whether an evening or dusk condition exists, which would automatically switch on streetlights. Conversely, with an increase in the amount of visible light, capacitive light sensing circuit 66 could detect a morning or dawn condition and automatically switch off the streetlights.

In yet another alternative aspect of the invention, light sensing film 44 integrated in capacitive light sensing circuit 66 may be used in the plastic processing industry as a sensor in an ultraviolet curing process. By exposing soft synthetic resins to ultraviolet light, resins can be hardened or softened. Reaction times of these polymers depend on the intensity of the ultraviolet light. By measuring the intensity of ultraviolet light with light sensing film 44, the optimal processing reaction time can be determined according to the measured value.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for detecting light intensity, the system comprising:
a light sensor for sensing light intensity having a capacitance which varies based on light intensity; and
a controller in communication with the sensor for measuring the capacitance of the sensor, comparing the measured capacitance values to stored capacitance values and generating an output signal based on the comparison, wherein the output signal is configured for use in providing an indication of light intensity.

2. The system of claim 1 wherein the sensor further comprises first and second layers forming first and second electrodes and a photosensitive dielectric layer disposed between the first and second electrodes, the photosensitive dielectric layer having a dielectric constant that varies with light intensity such that the sensor has a capacitance representative of light intensity.

3. The system of claim 2, wherein the sensor further comprises a transparent protective layer disposed proximate to the first electrode.

4. The system of claim 2, wherein the sensor further comprises a lower protective material disposed proximate the second electrode.

5. The system of claim 2, wherein the sensor further comprises a second dielectric layer disposed between the photosensitive dielectric layer and the second electrode to adjust a base capacitance of the sensor.

6. The system of claim 1 for use in a timepiece for detecting ultraviolet radiation levels.

7. The system of claim 6, wherein the timepiece is configured to generate an indication of ultraviolet radiation levels in response to the output signal.

8. The system of claim 7, wherein the timepiece includes a liquid crystal display for generating a visual indication of ultraviolet radiation levels in response to the output signal.

9. The system of claim 1 for use in actinometers for measuring visible light for use in adjusting aperture diaphragms of a camera.

10. The system of claim 1 for use in an automatic street light switching device for detecting visible sunlight.

11. The system of claim 1 for use in an ultraviolet curing process for use in detecting reaction times of polymers.

12. A light sensing film for detecting light intensity, the film comprising:
a protective layer;
a transparent first layer having a first electrode disposed proximate the protective layer;
a second layer having a second electrode extending generally parallel to the first layer; and
a photosensitive dielectric layer disposed between the first and second layers, the photosensitive dielectric layer having a dielectric constant that varies with light intensity such that the film has a capacitance representative of light intensity,
wherein the first and second electrodes detect variances in the dielectric constant of the dielectric material as a result of changes in the light intensity received by the dielectric layer to detect the capacitance of the light sensing film.

13. The light sensing film of claim 12 further comprising a second dielectric layer disposed between the photosensitive dielectric layer and the second electrode to adjust a base capacitance of the sensor.

14. The light sensing film of claim 13, wherein the second dielectric layer comprises barium titanate.

15. The light sensing film of claim 12 further comprising a lower protective material disposed proximate the second electrode.

16. The light sensing film of claim 12, wherein the photosensitive dielectric layer includes zinc sulfide.

17. The light sensing film of claim 12, wherein the protective layer is a transparent plastic film.

18. The light sensing film of claim 17, wherein the first electrode is formed into the plastic transparent protective layer.

19. The light sensing film of claim 18, wherein the first electrode comprises a transparent indium tin oxide (ITO) layer formed into a lower surface of the transparent protective layer.

20. A timepiece comprising:
a housing having a front surface;
a display face disposed in an aperture formed in the front surface of the housing;
a liquid crystal display panel disposed proximate the display face; and
a light sensor for sensing light intensity having a capacitance which varies based on light intensity, wherein the display panel provides an indication of light intensity based on an output signal from the light sensor.
